(19) United States
(12) Patent Application Publication
(10) Pub. No.: US 2007/0137705 A1
(43) Pub. Date: Jun. 21, 2007

(54) Pressure-relief and cutoff device for an air compressor

(75) Inventor: Sun-Fong Chen, Taipei Hsien (TW)

Correspondence Address: BACON & THOMAS, PLLC, 625 SLATERS LANE, FOURTH FLOOR, ALEXANDRIA, VA, 22314, US

(73) Assignee: Chile Auto Parts Co., Ltd., Hunan (CN)

(21) Appl. No.: 11/274,407

(22) Filed: Nov. 16, 2005

(51) Int. Cl. G05D 11/00

(52) U.S. Cl. 137/115.13; 417/44.9

(57) ABSTRACT

A pressure-relief and cutoff device for an air compressor has a body, a link rod, a cutoff assembly and a bleed assembly. The body has a first adapting tube connecting to a reservoir, a second adapting tube connecting to a pump and the reservoir and a bottom opening. The link rod is mounted movably in the body. The cutoff assembly has a diaphragm attached to the link rod, an actuating rod and two terminals electrically connecting to the motor. The terminals respectively have a resilient contact and a stationary contact. The bleed assembly has a stopper attached to the link rod and selectively sealing the bottom opening of the body. When the air pressure in the reservoir is too great, the air bends the diaphragm to push the resilient contact to disconnect from the contact to stop the motor. The pump stops operating immediately to prevent damage by backflow.

### BACKGROUND OF THE INVENTION

1. Field of the Invention

The present invention relates to a pressure-relief and cutoff device, especially to a pressure-relief and cutoff device for an air compressor.

2. Description of the Prior Arts

Air compressors are widely used to compress and store pressurized air to fill balls, balloons, tires, etc., or power pneumatic tools or machines. An air compressor comprises a motor, a pump and a reservoir. The motor drives the pump to pump air into the reservoir. When the air pressure in the reservoir is greater than the air pressure in the pump, the air reverses from the reservoir to the pump. The backflow of the air can cause damage to the pump if the pump is operating. Therefore, the air compressor further comprises a pressure-relief and cutoff device to prevent the backflow from damaging the pump.

With reference to FIG. 5, a conventional pressure-relief and cutoff device has a shell (90), a cutoff switch (91), a bleed valve (92), a bleed switch (93), an actuating element (94), a spring (95) and a rod (96). The cutoff switch (91) is mounted in the shell (90) and electrically connects to the motor of the air compressor. The bleed valve (92) is mounted on the shell (90) and connects to the reservoir of the air compressor. The bleed switch (93) is mounted on the bleed valve (92). The actuating element (94) is mounted movably in the shell (90) and has an inner end corresponding to the cutoff switch (91) and an outer end corresponding to the bleed switch (93). The spring (95) is mounted between the actuating element (94) and an inner wall of the shell (90). The rod (96) is mounted in the shell (90) and extends out of the shell (90).

With further reference to FIG. 6, the air pressure pushes the actuating element (94) upward when the air pressure in the reservoir is greater than the air pressure in the pump. The inner end of the actuating element (94) presses the cutoff switch (91) to disconnect the motor. The outer end of the actuating element (94) presses the bleed switch (93) to release air from the reservoir to decrease the air pressure in the reservoir. The pump stops operating so the backflow will not cause damage to the pump as well as to stop the pump from continuing to increase the air pressure. When the air pressure in the reservoir equalizes and returns to a desired level, the resilience of the spring (95) pushes the actuating element (94) downward to release the switches (91, 93). Then the motor starts operating again to drive the pump. The user can also use the rod (96) to push the actuating element (94) upward to manually control the air pressure by turning off the motor.

However, the actuating element (94) must move upward a certain distance to press the switches (91, 93) and must move downward a certain distance to release the switches (91, 93). When the actuating element (94) moves back and forth over time, the friction causes damage to the actuating element (94) to a point when the actuating element (94) may not be able to move far enough to press or release the switches (91, 93). The pump may not be stopped immediately and can easily suffer damage.

To overcome the shortcomings, the present invention provides an improved pressure-relief and cutoff device for an air compressor to mitigate or obviate the aforementioned problems.

### SUMMARY OF THE INVENTION

The main objective of the present invention is to provide an improved pressure-relief and cutoff device for an air compressor to stop a pump immediately. The pressure-relief and cutoff device for an air compressor has a body, a link rod, a cutoff assembly and a bleed assembly. The body has a first adapting tube connecting to the reservoir, a second adapting tube connecting to the pump and the reservoir and an opening in a bottom end. The link rod is mounted movably in the body. The cutoff assembly has a diaphragm attached to the link rod, an actuating rod and two terminals electrically connecting to the motor. The terminals respectively have a resilient contact and a corresponding contact. The bleed assembly has a stopper attached to the link rod and selectively seals the opening in the bottom end of the body. When the air pressure in the reservoir is too great, the air pressure causes the diaphragm to bend. The diaphragm pushes the resilient contact to disconnect from the contact to stop the motor. The pump then stops operating immediately to prevent damage by the backflow.

Other objectives, advantages and novel features of the invention will become more apparent from the following detailed description when taken in conjunction with the accompanying drawings.

### BRIEF DESCRIPTION OF THE DRAWINGS

FIG. 1 is an exploded side view of a pressure-relief and cutoff device for an air compressor in accordance with the present invention;

FIG. 2 is a side view in partial section of the pressure-relief and cutoff device in FIG. 1;

FIG. 3 is an operational view of the pressure-relief and cutoff device in FIG. 1 with an air compressor and a reservoir;

FIG. 4 is an operational side view in partial section of the pressure-relief and cutoff device in FIG. 1;

FIG. 5 is a side view of a conventional pressure-relief and cutoff device in accordance with the prior art; and

FIG. 6 is an operational side view of the conventional pressure-relief and cutoff device in FIG. 5.

### DETAILED DESCRIPTION OF THE PREFERRED EMBODIMENTS

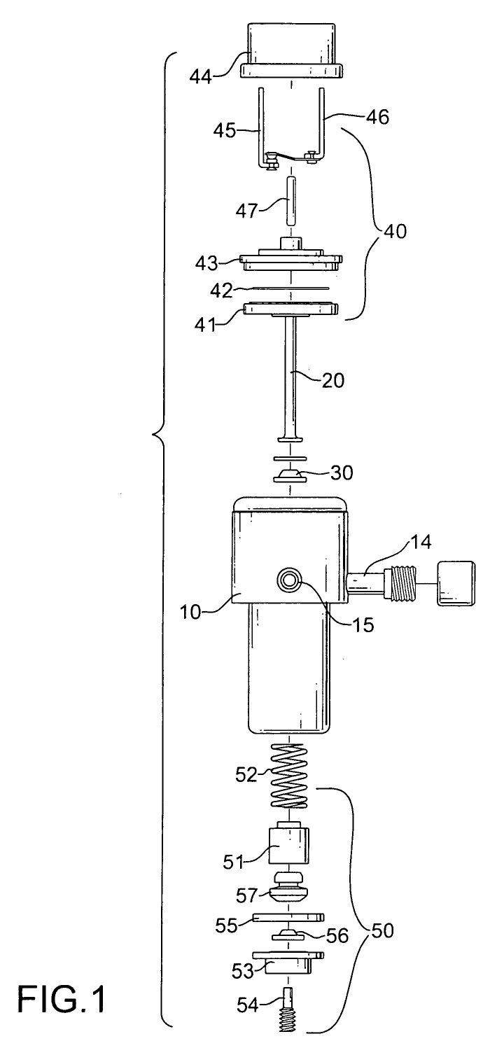

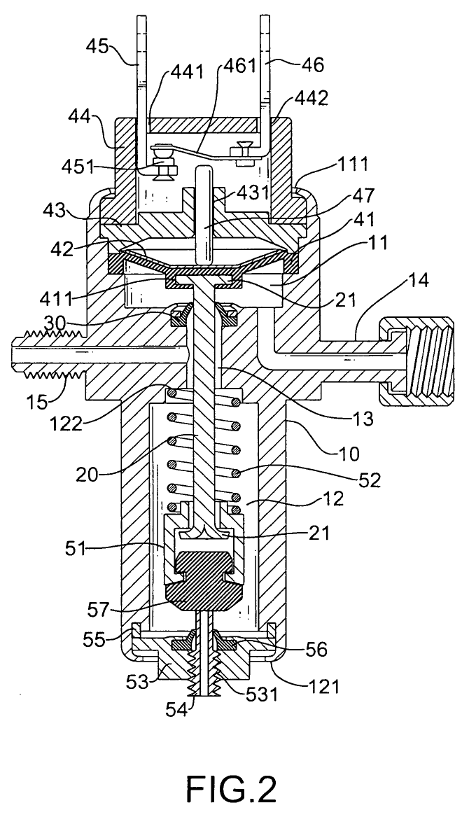

With reference to FIGS. 1 and 2, a pressure-relief and cutoff device for an air compressor in accordance with the present invention comprises a body (10), a link rod (20), a sealing washer (30), a cutoff assembly (40) and a bleed assembly (50).

The body (10) is tubular and comprises a top end (111), a bottom end (121), a sidewall, a cutoff chamber (11), a bleed chamber (12), a connecting chamber (13), a first adapting tube (14) and a second adapting tube (15). The top end (111) may be an open end. The bottom end (121) is an open end. The cutoff chamber (11) is formed in the body (10) adjacent to the top end (111). The bleed chamber (12) is formed in the body (10) adjacent to the bottom end (121) and may have an inner wall (122) defined adjacent to the connecting chamber (13). The connecting chamber (13) is formed in the body (10) and is between and communicates with the cutoff chamber (11) and the bleed chamber (12). The first adapting tube (14) is formed in and extends out of the sidewall of the body (10) and communicates with the cutoff chamber (11). The second adapting tube (15) is formed in and extends out of the sidewall of the body (10) and communicates with the bleed chamber (12) and the connecting chamber (13).

The link rod (20) is mounted in the connecting chamber (13) in the body (10) and has a top end, a bottom end and two optional annular flanges (21). The top end of the link rod (20) extends into the cutoff chamber (11) in the body (10). The bottom end of the link rod (20) extends into the bleed chamber (12) in the body (10). The annular flanges (21) are formed respectively around the top and bottom ends of the link rod (20).

The sealing washer (30) is mounted around the link rod (20) between the cutoff chamber (11) and the connecting chamber (13) to seal the cutoff chamber (11) from the connecting chamber (13).

The cutoff assembly (40) is mounted in the cutoff chamber (11) and has a spacer (41), a diaphragm (42), an optional top cap (43), an optional insulating cap (44), a stationary terminal (45), a resilient terminal (46) and an actuating rod (47). The spacer (41) is attached to the top end of the link rod (20), has an edge, a top surface and a bottom surface and may comprise a mounting recess (411). The edge of the spacer (41) is mounted securely in the cutoff chamber (11) in the body (10). The mounting recess (411) is formed in the bottom surface of the spacer (41) and engages the annular flange (21) on the top end of the link rod (20). The diaphragm (42) is attached to the top surface of the spacer (41) and has an edge. The edge of the diaphragm (42) is mounted securely in the cutoff chamber (11) in the body (10). The top cap (43) is mounted in and seals the top end (111) of the body (10) and has a through hole (431). The through hole (431) is formed through the top cap (43). The insulating cap (44) is mounted in and extends out of the top end (111) of the body (10) and has two through holes (441, 442). The through holes (441, 442) are formed separately through the insulating cap (44). The stationary terminal (45) is mounted securely in the top end (111) of the body (10), may be mounted securely in the through hole (441) in the insulating cap (44), may extend out of the insulating cap (44) and comprises an outer end, an inner end and a contact (451). The contact (451) is formed on the inner end of the stationary terminal (45). The resilient terminal (46) is mounted securely in the top end (111) of the body (10), may be mounted securely in the through hole (442) in the insulating cap (44), may extend out of the insulating cap (44) and comprises an outer end, an inner end and a resilient contact (461). The resilient contact (461) is formed on the inner end of the resilient terminal (46) and selectively connects electrically to the contact (451) on the stationary terminal (45). The actuating rod (47) is mounted movably in the cutoff chamber (11), may be mounted in the through hole (431) in the top cap (43) and has a bottom end and a top end. The bottom end of the actuating rod (47) contacts the diaphragm (42). The top end of the actuating rod (47) selectively contacts the resilient contact (461) on the resilient terminal (46).

The bleed assembly (50) is mounted in the bleed chamber (12) in the body (10), has a stopper (57) and may have a mounting head (51), a spring (52), a bottom cap (53), an extension tube (54), a ring (55) and a washer (56). The stopper (57) is attached to the bottom end of the link rod (20) and selectively seals the bottom end of the body (10). The mounting head (51) is mounted securely around the annular flange (21) on the bottom end of the link rod (20) to attach the stopper (57) to the bottom end of the link rod (20). The spring (52) is mounted around the link rod (20) and is pressed between the inner wall (122) of the bleed chamber (12) and the mounting head (51). The bottom cap (53) is mounted in and seals the bottom end (121) of the body (10) and has a through hole (531). The through hole (531) is formed through the bottom cap (53). The extension tube (54) is mounted securely in the through hole (531) and has an inner opening and an outer opening. The inner opening is selectively sealed by the stopper (57). The ring (55) is mounted around the extension tube (54). The washer (56) is mounted around the extension tube (54).

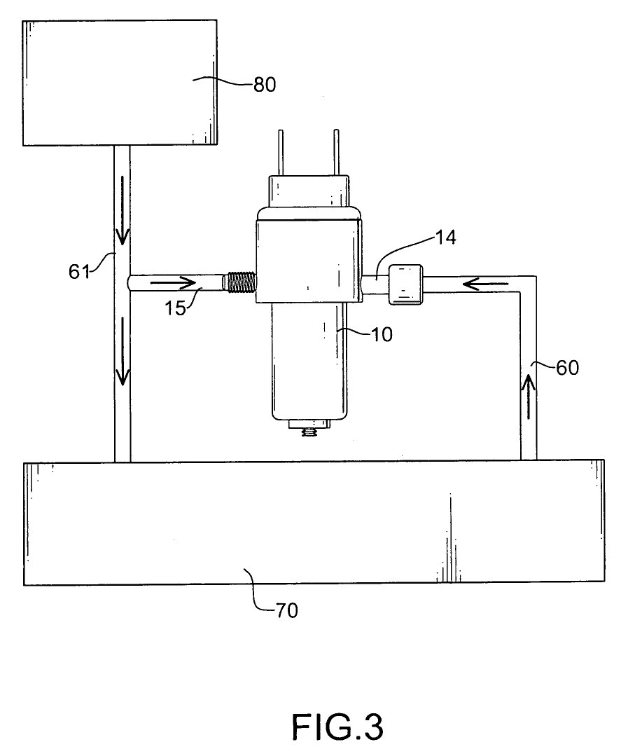

With further reference to FIG. 3, the air compressor comprises a motor (not shown), a reservoir (70), a pump (80), a first air tube (60) and a second air tube (61). The motor drives the pump to operate. The first air tube (60) connects to and communicates with the reservoir (70) and the first adapting tube (14). The second air tube (61) connects to and communicates with the pump (80), the reservoir (70) and the second adapting tube (15). The pump (80) pumps air through the second air tube (61) into the second adapting tube (15) and the reservoir (70). The air in the reservoir (70) flows into or fills the object or appliance that needs to be inflated or needs compressed air. The air in the reservoir (70) also flows into the first air tube (60) and into the first adapting tube (14). The stationary and resilient terminals (45, 46) are electrically connected to the motor. When the resilient contact (461) of the resilient terminal (46) disconnects from the contact (451) of the stationary terminal (45), the motor stops. When the resilient contact (461) of the resilient terminal (46) connects with the contact (451) of the stationary terminal (45), the motor operates.

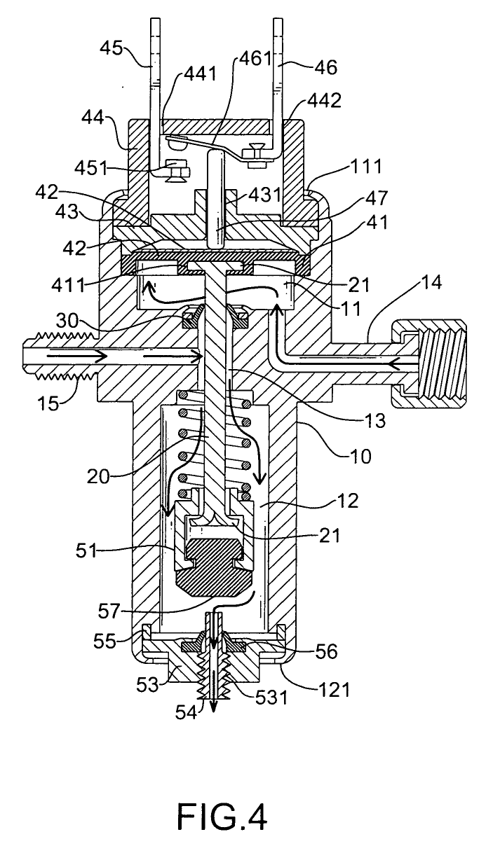

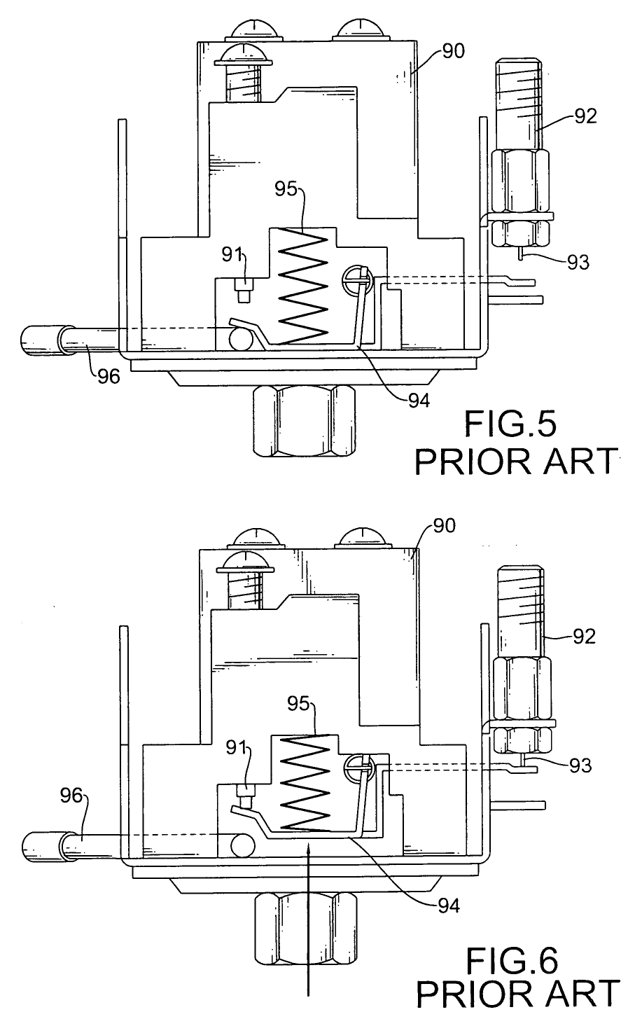

With further reference to FIG. 4, the air pressure pushes the spacer (41) and the diaphragm (42) to bend upward when the air pressure in the reservoir is great enough. The diaphragm (42) pushes the actuating rod (47) to push the resilient contact (461). The resilient contact (461) disconnects from the contact (451) to stop the motor. Then the pump (80) stops operating to prevent the backflow from damaging the pump (80). The spacer (41) pulls the link rod (20) upward to unseat the stopper (57) from the bottom end (121) of the body (10). Then the air bleeds out from the bottom end (121) of the body (10) to decrease the air pressure in the reservoir (70). When the air pressure in the reservoir (70) equalizes to a desired level, the resilience of the diaphragm (42) recovers the diaphragm (42). The actuating rod (47) drops downward and the resilient contact (461) connects with the contact (451) to restart the motor. The link rod (20) is pushed downward and the stopper (57) seals the bottom end (121) of the body (10) to stop the release of air.

The advantage of the present invention is the use of the resilient contact (461) to selectively disconnect from the contact (451) to control the motor. The actuating rod (47) only has to move a little to break the connection between the contacts (451)(461). Therefore, the pump can be stopped immediately to prevent damage.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pressure-relief and cutoff device for an air compressor comprising:
a body being tubular and comprising a top end;
a bottom end with an opening;
a sidewall;
a cutoff chamber formed in the body adjacent to the top end;
a bleed chamber formed in the body adjacent to the bottom end;
a connecting chamber formed in the body and being between and communicating with the cutoff chamber and the bleed chamber;
a first adapting tube formed in and extending out of the sidewall of the body and communicating with the cutoff chamber; and
a second adapting tube formed in and extending out of the sidewall of the body and communicating with the bleed chamber and the connecting chamber;
a link rod mounted in the connecting chamber in the body and having a top end extending into the cutoff chamber in the body; and
a bottom end extending into the bleed chamber in the body;
a sealing washer mounted around the link rod between the cutoff chamber and the connecting chamber;
a cutoff assembly mounted in the cutoff chamber and having
a spacer attached to the top end of the link rod and having
an edge mounted securely in the cutoff chamber in the body;
a top surface; and
a bottom surface;
a diaphragm attached to the top surface of the spacer and having an edge mounted securely in the cutoff chamber in the body;
a stationary terminal mounted securely in the top end of the body and comprising
an outer end;
an inner end; and
a contact formed on inner end of the stationary terminal;
a resilient terminal mounted securely in the top end of the body and comprising
an outer end;
an inner end; and
a resilient contact formed on the inner end of the resilient terminal and selectively connecting electrically to the contact on the stationary terminal; and
an actuating rod mounted movably in the cutoff chamber and having
a bottom end contacting the diaphragm; and
a top end selectively contacting the resilient contact on the resilient terminal; and
a bleed assembly mounted in the bleed chamber in the body and having a stopper attached to the bottom end of the link rod and selectively sealing the bottom end of the body.

2. The pressure-relief and cutoff device as claimed in claim 1, wherein
the top end of the body is an open end;
the cutoff assembly has
a top cap mounted in and sealing the top end of the body and having a through hole formed through the top cap; and
an insulating cap mounted in and extending out of the top end of the body and having two through holes formed separately through the insulating cap;
the stationary terminal is mounted securely in the through hole in the insulating cap and extends out of the insulating cap;
the resilient terminal is mounted securely in the through hole in the insulating cap and extends out of the insulating cap; and
the actuating rod is mounted in the through hole in the top cap.

3. The pressure-relief and cutoff device as claimed in claim 1, wherein
the link rod has an annular flange formed around the top end of the link rod; and
the spacer has a mounting recess formed in the bottom surface of the spacer and engages the annular flange on the top end of the link rod.

4. The pressure-relief and cutoff device as claimed in claim 2, wherein
the link rod has an annular flange formed around the top end of the link rod; and
the spacer has a mounting recess formed in the bottom surface of the spacer and engaging the annular flange on the top end of the link rod.

5. The pressure-relief and cutoff device as claimed in claim 1, wherein
the bleed chamber has an inner wall adjacent to the connecting chamber;
the link rod has an annular flange formed around the bottom end of the link rod; and
the bleed assembly has
a mounting head mounted securely around the annular flange on the bottom end of the link rod to attach the stopper to the bottom end of the link rod; and
a spring mounted around the link rod and pressed between the inner wall of the bleed chamber and the mounting head.

6. The pressure-relief and cutoff device as claimed in claim 4, wherein
the bleed chamber has an inner wall adjacent to the connecting chamber;
the link rod has an annular flange formed around the bottom end of the link rod; and
the bleed assembly has
a mounting head mounted securely around the annular flange on the bottom end of the link rod to attach the stopper to the bottom end of the link rod; and
a spring mounted around the link rod and pressed between the inner wall of the bleed chamber and the mounting head.

7. The pressure-relief and cutoff device as claimed in claim 1, wherein the bleed assembly has
a bottom cap mounted in and sealing the bottom end of the body and comprising a through hole formed through the bottom cap;
an extension tube mounted securely in the through hole and having
an inner opening selectively sealed by the stopper; and
an outer opening;
a ring mounted around the extension tube; and
a washer mounted around the extension tube.

8. The pressure-relief and cutoff device as claimed in claim 6, wherein the bleed assembly has
a bottom cap mounted in and sealing the bottom end of the body and comprising a through hole formed through the bottom cap;
an extension tube mounted securely in the through hole and having
an inner opening selectively sealed by the stopper; and
an outer opening;
a ring mounted around the extension tube; and
a washer mounted around the extension tube.
